(19) United States
(12) Patent Application Publication
(10) Pub. No.: US 2025/0382769 A1
(43) Pub. Date: Dec. 18, 2025

(54) SLOPE WORK VEHICLE AND METHOD OF MOVING SLOPE WORK VEHICLE

(71) Applicant: Toshihito OKAMOTO, Chiba (JP)

(72) Inventor: Toshihito OKAMOTO, Chiba (JP)

(21) Appl. No.: 18/833,615

(22) PCT Filed: Feb. 9, 2022
(86) PCT No.: PCT/JP2022/005023

§ 371 Date: Mar. 5, 2025

(51) Int. Cl. E02F 9/20; E02F 3/32

(52) U.S. Cl. CPC E02F 9/2016; E02F 3/32

(57) ABSTRACT

An object of the present invention is to provide a slope work vehicle and a moving method for a slope work vehicle on a slope, the slope work vehicle characterized by including: a work vehicle main body; left and right traveling apparatuses that are provided in the work vehicle main body; left and right winches that are provided in the work vehicle main body and each include a wire; a winch operating means capable of individually operating the left and right winches; a tension detecting means for respectively detecting a loosened state of the wires; and a work machine that is provided in the work vehicle main body, in which the slope work vehicle is capable of efficiently moving in a left/right direction.

### BACKGROUND OF THE INVENTION

### 1. Field of the Invention

The present invention relates to a slope work vehicle that moves on a slope and performs work such as drilling, and a moving method for a slope work vehicle.

### 2. Description of the Related Art

Conventionally, as an example of a slope work vehicle that is suspended on a slope by a wire on a winch and performs work on the slope while traveling on the slope, “a work machine for a slope or the like characterized by including: a vehicle body; a traveling apparatus that is attached to the vehicle body and enables the vehicle body to travel by hydraulic pressure; a single base plate that is attached to a substantially center portion of the vehicle body such as to be rotatable in a horizontal direction; a base plate rotation apparatus that rotates the single base plate and uses hydraulic pressure; a workbench that is attached to a substantially center portion of the single base plate such as to be rotatable in the horizontal direction; a workbench rotation apparatus that rotates the workbench and uses hydraulic pressure; and a fall prevention apparatus that uses a pair of attachment fittings to attach a pair of winches attached to the single base plate or tip end portions of wires wound onto the pair of winches” is known (Patent Literature 1).

In the work machine for a slope or the like such as this, as a result of the wires provided on the pair of winches being fixed to anchors in an upper portion of the slope so as to form a substantially V-like shape from a planar view, the work vehicle can be moved not only in an up/down direction of the slope but also in a left/right direction.

However, when the slope work vehicle configured as described above is used, although the slope work vehicle can be move in the left/right direction up to a breadth of the anchors, if the slope work vehicle is to be moved in the left/right direction beyond the anchors, work in which the slope work vehicle is temporarily moved to level ground or a gentle slope, the anchor is re-driven into the upper portion of the slope, and further, the wires are reattached is necessary. Therefore, there is a disadvantage in that work efficiency decreases.
[Patent Literature 1] Japanese Patent Publication No. 4755952

In light of conventional disadvantages such as those described above, an object of the present invention is to provide a slope work vehicle that is capable of efficiently moving in a left/right direction and a moving method for a slope work vehicle on a slope.

### SUMMARY OF THE INVENTION

To achieve the above-described object, a slope work vehicle according to a first aspect of the present invention is characterized by being configured by: a work vehicle main body; left and right traveling apparatuses that are provided in the work vehicle main body; left and right winches that are provided in the work vehicle main body and each include a wire; a winch operating means capable of individually operating the left and right winches; a tension detecting means for respectively detecting a loosened state of the wires; and a work machine that is provided in the work vehicle main body.

A slope work vehicle according to a second aspect is characterized by further including: left and right wire fairleaders that are provided in the work vehicle main body and respectively guide the wires on the left and right winches to a frontward side from a front of the work vehicle main body; and a spacing displacing means for displacing a distance in a left/right direction between the wire fairleaders.

A moving method for a slope work vehicle according to a third embodiment is a moving method for a slope work vehicle that is capable of traveling on a slope and performing work, the moving method including: a slope work vehicle moving step of respectively connecting one and another wire respectively provided on left and right winches to one anchor and another anchor on the slope so as to form a substantially V-like shape from a planar view and moving the slope work vehicle that is disposed on the slope in a state of being supported by the one and the other wires to be substantially vertically below the one anchor; an other wire loosening step of loosening the other wire that is connected to the other anchor and holding the slope work vehicle by only the one wire that is connected to the one anchor; an other wire moving step of connecting the other wire to the one anchor; and a one wire moving step of holding the slope work vehicle by the other wire and connecting the one wire to a third anchor that is provided outside of the one anchor in a left/right direction in a direction opposite the other anchor.

### Effects of the Invention

As is clear from the descriptions above, effects listed as follows are achieved in the present invention.
(1) In the inventions according to the first aspect and the third aspect, as a result of the winch operating means that is capable of individually operating the left and right winches and the tension detecting means for detecting the loosened state of the wires respectively provided on the left and right winches, a suspension state of the slope work vehicle can be adjusted as appropriate, and attachment and removal of a wire can be performed even in a state of suspension on a slope. Consequently, the slope work vehicle can be efficiently moved in the left/right direction.
(2) In the invention according to the second aspect, in addition to effects similar to those in (1) above being achieved, because a work apparatus can be prevented from interfering with wires on a slope, work can be safely performed.

### BRIEF DESCRIPTION OF THE DRAWING

FIG. 1 to FIG. 9 are explanatory diagrams according to a first embodiment of the present invention.

FIG. 1 is an explanatory diagram of a slope work vehicle according to a first embodiment;

FIG. 2 is a planar view of the slope work vehicle according to the first embodiment;

FIG. 3 is a flowchart of a moving method for the slope work vehicle according to the first embodiment;

FIG. 4 is a block diagram of a tension detecting means and the like of the slope work vehicle;

FIG. 5 is a planar view of the slope work vehicle disposed on a slope;

FIG. 6 is an explanatory diagram of a slope work vehicle moving step;

FIG. 7 is an explanatory diagram of an other wire loosening step;

FIG. 8 is an explanatory diagram of an other wire moving step; and

FIG. 9 is an explanatory diagram of a one wire moving step.

### EXPLANATION OF REFERENCE NUMBERS

1: slope work vehicle
2: slope
3: work vehicle main body
4: traveling apparatus
5: wire
6: winch
7: winch operating means
8: tension detecting means
9: wire fairleader
10: work machine
11: spacing displacing means
12: operating seat
13: communication means
14: angle adjusting means
15: support base
16: pivot pin
17: base plate
18: hydraulic cylinder
19: pantograph
20: turning mechanism
21: driving arm
22: work attachment
23: hydraulic pump
24: engine
25: anchor
26: moving method for slope work vehicle
27: slope work vehicle moving step
28: other wire loosening step
29: other wire moving step
30: one wire moving step

### DETAILED DESCRIPTION OF THE PREFERRED EMBODIMENTS

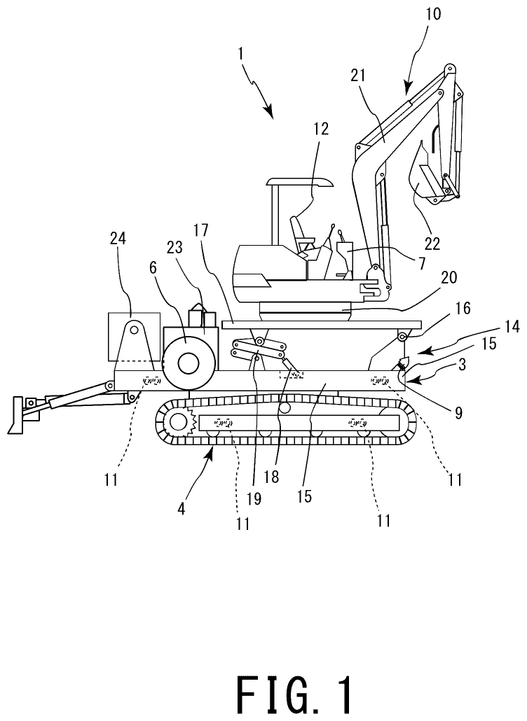

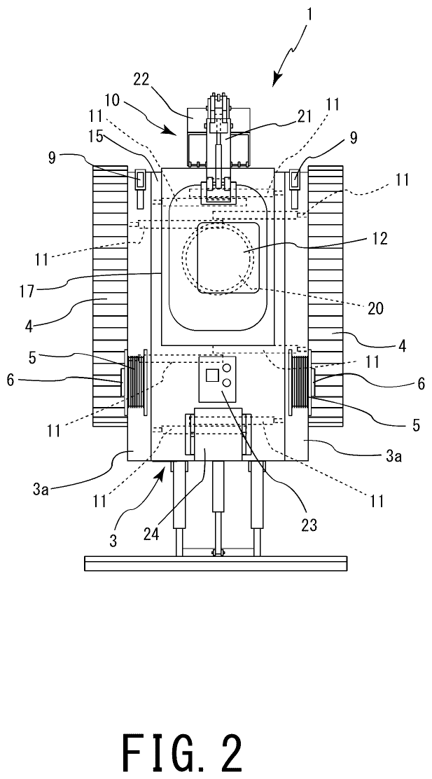

The present invention will hereinafter be described in detail according to embodiments for carrying out the present invention shown in the drawings. Here, a left/right direction is a left/right direction in FIG. 2 (planar view). A front/rear direction is a left/right direction in FIG. 1. An up/down direction is an up/down direction in FIG. 1.

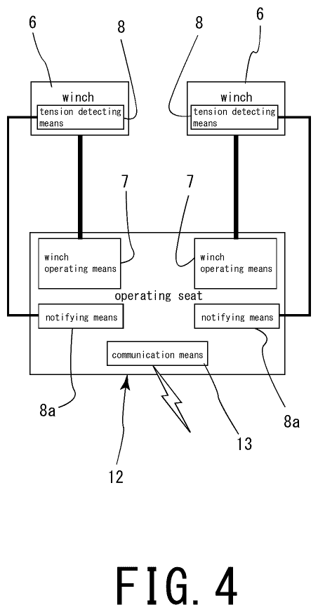

According to a first embodiment for carrying out the present invention shown in FIG. 1 to FIG. 9, 1 denotes a slope work vehicle that is capable of working on a slope 2 that has a steep gradient shape of, for example, 40 degrees or 45 degrees. The slope work vehicle 1 according to the embodiment is suitable for working on the slope 2 that has a steep gradient shape of at least 40 degrees or greater.

Specifically, as shown in FIG. 1 that is a side view and FIG. 2 that is a planar view when FIG. 1 is horizontally rotated substantially 90 degrees to the right, the slope work vehicle 1 is configured by: a work vehicle main body 3; a pair of left and right traveling apparatuses 4 that are provided in the work vehicle main body 3; a pair of left and right winches 6 that are provided in the work vehicle main body 3 and each include a wire 5; a pair of left and right winch operating means 7 that can individually operate the pair of left and right winches; a pair of tension detecting means 8 that respectively detect a loosened state of the pair of left and right wires 5; a pair of left and right wire fairleaders 9 that are provided in appropriate locations of the work vehicle main body 3 and respectively guide the wires 5 of the pair of left and right winches 6; a work machine 10 (such as a hydraulic shovel) that is turnably provided in the work vehicle main body 3; and a spacing displacing means (such as a spanner) 11 that can respectively displace, in the left/right direction, relative distances between the pair of left and right traveling apparatuses 4 and between the wire fairleaders 9.

The work vehicle main body 3 includes the traveling apparatuses 4 in a bottom portion thereof. According to the present embodiment, caterpillars are used on the left and right as an example of the traveling apparatuses 4. Here, tires, rather than the caterpillars 4 according to the embodiment, may be used as the traveling apparatuses 4.

The traveling apparatuses 4 are displaced in the left/right direction by operation of the spacing displacing means 11 provided in the traveling apparatuses 4. When work is carried out by the hydraulic shovel 10, a distance between the left and right traveling apparatuses 4 is increased as a result of the spacing displacing means 11 (hereinafter also referred to as a “spanner 11”) being extended, and work can be stably performed.

An operating seat 12 is provided in the work vehicle main body 3. The winch operating means 7 that can individually operate the traveling apparatuses 4, the spanners 11, and the left and right winches 6, and the tension detecting means 8 that detect the loosened state of the wires 5 are provided in the operating seat 12.

According to the present embodiment, the tension detecting means 8 respectively detect tension in the wires 5 and have a pair of notifying means 8a that notify a worker in the operating seat 12. Here, the tension detecting means 8 may be configured to be capable of detecting the tension in the wire 5 in cooperation with the winch operating means 7, with a control means or the like therebetween, and automatically adjusting the tension in the wire 5 provided in each of the left and right winches 6 to a predetermined tension. In addition, as the tension detecting means 8, in addition to that which detects the tension in the wire 5, for example, a sensor that detects slack in the wire 5 or an apparatus such as a reference device that enables visual confirmation of slack may be provided.

In addition, the operating seat 12 includes a communication means 13 that enables communication with the outside (someone not on board the slope work vehicle). The communication means 13 has a transmitting and receiving function. According to the present embodiment, the communication means 13 is provided in the operating seat 12. However, a wireless or portable communication terminal carried by a worker may serve as the communication means 13.

The wire fairleaders 9 are provided in telescopic portions 3a that are provided in left and right sections of the work vehicle main body 3. During work, the telescopic portion 3a is extended by the spanner 11 and a distance (relative distance) in the left/right direction between the left and right wire fairleaders 9 is increased. As a result, a distance between the left and right wires 5 is also increased. Consequently, work can be safely and efficiently performed without interference with the wires 5 even when the work machine 10 turns to work.

The hydraulic shovel 10 is provided in an upper portion of the work vehicle main body 3. According to the present embodiment, the hydraulic shovel 10 is provided in the work vehicle main body 3 with an angle adjusting means 14 therebetween, the angle adjusting means 14 enabling the hydraulic shovel 10 to be substantially horizontal even on a slope.

The angle adjusting means 14 is configured by a base plate 17 of which one end portion is attached to a support base 15 of the work vehicle main body 3 by a pivot pin 16 so that another end portion is rotatable in the up/down direction, and a hydraulic cylinder 18 and a pantograph 19 that are provided in a rear portion side of the base plate 17 and rotate the base plate 17 in the up/down direction with the pivot pin 16 as a fulcrum.

The hydraulic shovel 10 includes the operating seat 12 that is provided on the base plate 17 with a turning mechanism 20 therebetween so as to be turnable in the substantially horizontal direction, a driving arm 21 that is attached to a front end portion of the operating seat 12 (right side of the drawing in FIG. 1 and upper side of the drawing in FIG. 2), and a bucket 22, a breaker 22, or the like that serves as a work attachment 22 that is detachably attached to a tip end portion of the driving arm 21.

Incidentally, work apparatuses and work members such as the traveling apparatus 4, the winch 6, the hydraulic shovel 10, and the spanner 11 are each driven by a hydraulic pump 23. An engine 24 for operating the hydraulic pump 23 is rotatably provided in the rear of the work vehicle main body 3. As a result of the engine 24 being provided in this manner, even during movement on the slope 2, the engine 24 can be held in a substantially horizontal state at all times by gravitational force. Seizing of the engine 24 and the like can be prevented.

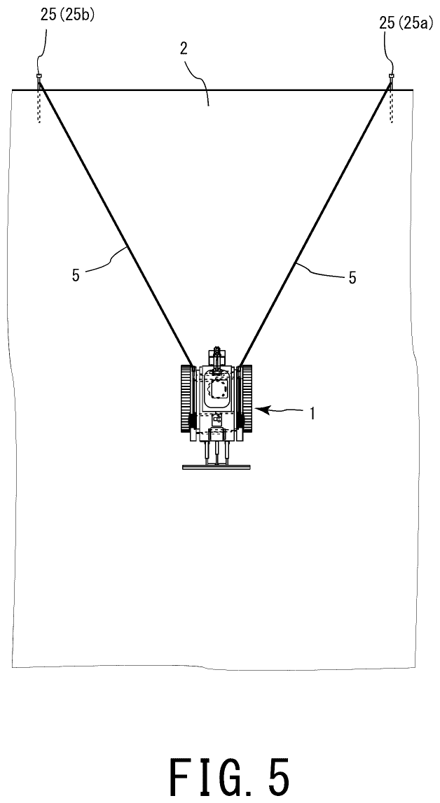

When work is performed on the slope 2, the slope work vehicle 1 is positioned in a lower portion of the slope 2, and the tip end portions of the wires 5 on the left and right winches 6 are fixed to the anchors 25 in the upper portion of the slope to form a substantially V-like shape from a planar view (see FIG. 5).

Then, once the wires 5 are fixed to the anchors 25, the winches 6 are wound by the winch operating means 7 near the operating seat 12. In addition, the traveling apparatuses 4 are operated and the slope work vehicle 1 advances forward. When a section having an angle steep enough that the traveling apparatuses 4 are unable to travel is reached, the slope work vehicle 1 advances forward by the wires 5 being wound by the winches 6 and is moved to a work position.

When the slope work vehicle 1 reaches the work position, work is performed on the slope by the work machine 10. In addition, work is performed as appropriate while moving in the left/right direction between the left and right anchors 25.

In a case in which work in a section outside the anchors 25 on the left and right is performed, movement in the left/right direction by a moving method 26 for a slope work vehicle of the present invention is performed.

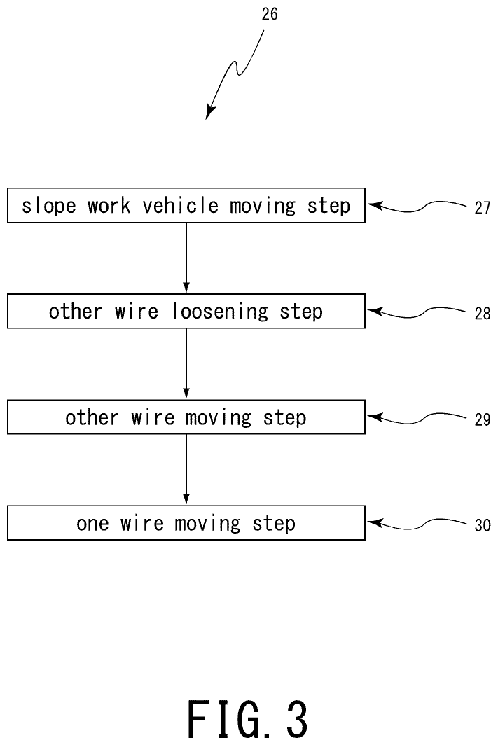

As shown in FIG. 3, the moving method 26 for a slope work vehicle includes: a slope work vehicle moving step 27 of respectively connecting one and the other wires 5 respectively provided on the pair of left and right winches 6 to one anchor 25a and the other anchor 25b on the slope 2 so as to form a substantially V-like shape from a planar view and moving the slope work vehicle 1 that is disposed on the slope 2 in a state of being supported by the one and the other wires 5 to be substantially vertically below the one anchor 25a; an other wire loosening step 28 of loosening the other wire 5 that is connected to the other anchor 25b and holding the slope work vehicle 1 by only the one wire 5 that is connected to the one anchor 25a; an other wire moving step 29 of connecting the other wire 5 to the one anchor 25a; and a one wire moving step 30 of holding the slope work vehicle 1 by the other wire 5 and connecting the one wire 5 to a third anchor 25c that is provided on an outer side in the left/right direction of the one anchor 25a in a direction opposite the other anchor 25b.

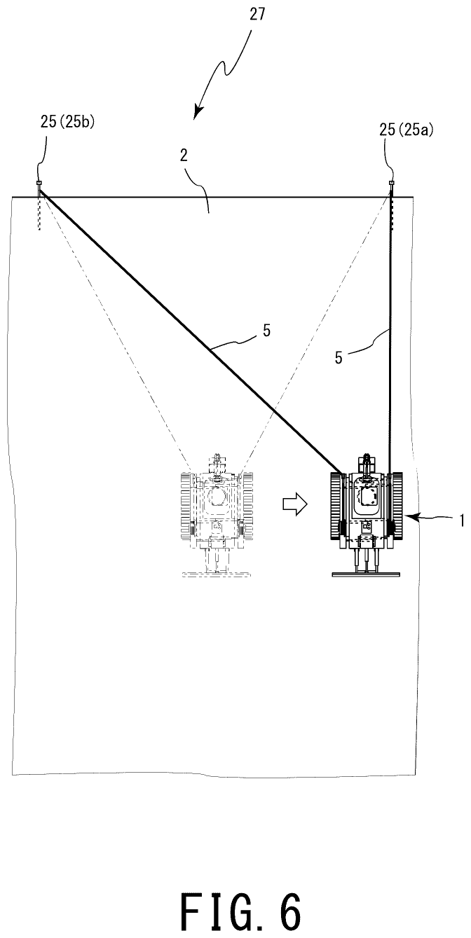

At the slope work vehicle moving step 27, as shown in FIG. 6, when work is to be performed further to the right of the anchor (one anchor 25a) on the right side, for example, of the left and right anchors 25 as described above, first, the slope work vehicle 1 is moved to be substantially vertically below the one anchor 25a.

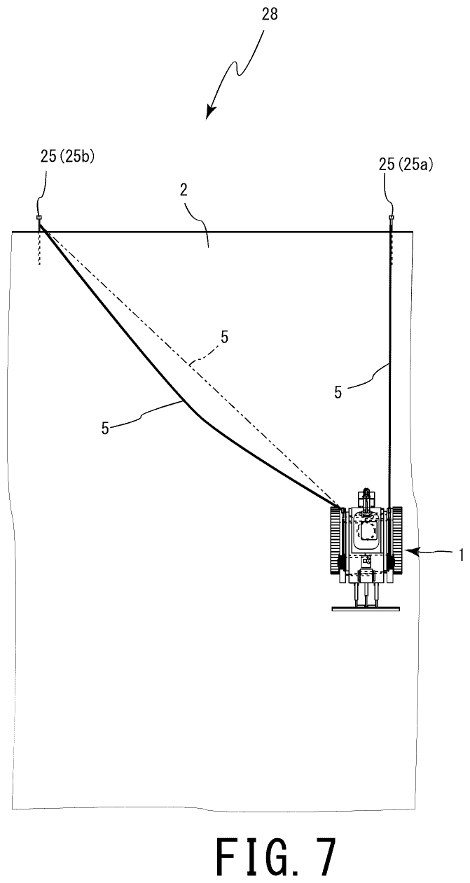

Subsequently, as shown in FIG. 7, the other wire loosening step 28 in which the one wire 5 is wound so that the slope work vehicle 1 is suspended by only the wire 5 (one wire 5) that is connected to the one anchor 25a and the other wire 5 is loosened to a state in which tension is not applied to the other wire 5 is performed. At this time, confirmation that tension is not applied to the other wire 5 is preferably performed using the tension detecting means 8. Here, slack in the other wire 5 may be confirmed by visual inspection of the work vehicle from the operating seat 12.

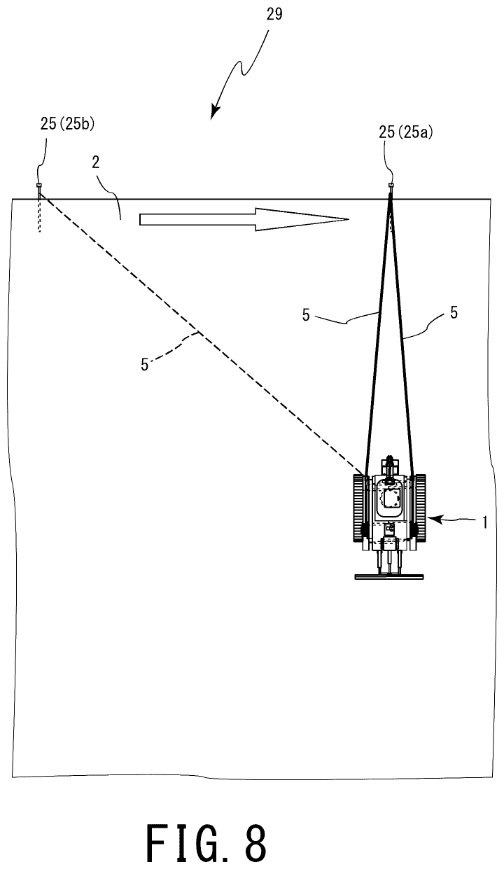

Next, communication to an outside worker is performed through the communication means 13. As shown in FIG. 8, the other wire moving step 29 in which the other wire 5 is removed from the other anchor 25b and the other wire 5 is connected to the one anchor 25a is performed. That is, the slope work vehicle 1 is held by both the one wire 5 and the other wire 5 being connected to the one anchor 25a.

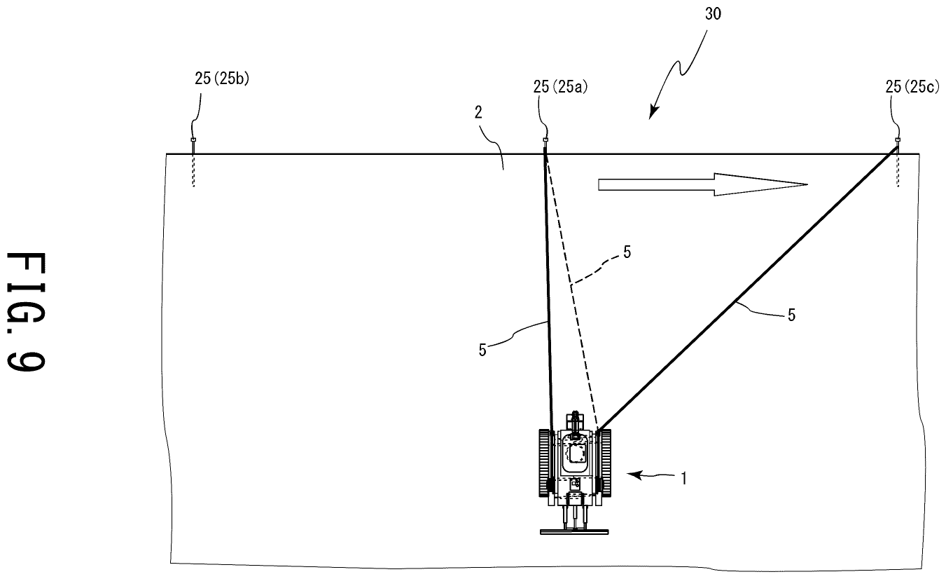

Next, as shown in FIG. 9, the one wire moving step 30 is performed. At the one wire moving step 30, first, the slope work vehicle 1 is held by the other wire 5 being wound so that tension is applied to the other wire 5. In addition, the one wire 5 is loosened to a state in which tension is not applied. At this time as well, confirmation that tension is not applied to the one wire 5 is preferably performed using the tension detecting means. However, slack in the one wire 5 may be confirmed by visual inspection of the work vehicle from the operating seat 12. Subsequently, communication with an outside worker is performed through the communication means 12. As a result of the one wire 5 being connected to the third anchor 25c that is provided on the outer side in the left/right direction of the one anchor 25a in a direction opposite the other anchor 25b, movement of the slope work vehicle 1 in the lateral direction is completed. Work on the slope between the one anchor 25a and the third anchor 25c can be performed.

### INDUSTRIAL APPLICABILITY

The present invention is used in an industry that manufactures slope work vehicles used in cases in which the slope work vehicle is suspended by a wire on a winch and performs various types of work on a sloping land having a steep gradient, such as a slope, and an industry that performs construction and the like on a slope using the slope work vehicle.

What is claimed is:

1. A slope work vehicle comprising:
a work vehicle main body;
left and right traveling apparatuses that are provided in the work vehicle main body;
left and right winches that are provided in the work vehicle main body and each include a wire;
a winch operating means capable of individually operating the left and right winches;
a tension detecting means for respectively detecting a loosened state of the wires; and
a work machine that is provided in the work vehicle main body.

2. The slope work machine according to claim 1, characterized by further comprising:
left and right wire fairleaders that are provided in the work vehicle main body and respectively guide the wires on the left and right winches to a frontward side from a front of the work vehicle main body; and
a spacing displacing means for displacing a distance in a left/right direction between the wire fairleaders.

3. A moving method for a slope work vehicle that is capable of traveling on a slope and performing work, the moving method comprising:
a slope work vehicle moving step of respectively connecting one and another wire respectively provided on left and right winches to one anchor and another anchor on the slope so as to form a substantially V-like shape from a planar view and moving the slope work vehicle that is disposed on the slope in a state of being supported by the one and the other wires to be substantially vertically below the one anchor;
an other wire loosening step of loosening the other wire that is connected to the other anchor and holding the slope work vehicle by only the one wire that is connected to the one anchor;
an other wire moving step of connecting the other wire to the one anchor; and
a one wire moving step of holding the slope work vehicle by the other wire and connecting the one wire to a third anchor that is provided outside of the one anchor in a left/right direction in a direction opposite the other anchor.
